(19) United States
(12) Patent Application Publication
(10) Pub. No.: US 2023/0047045 A1
(43) Pub. Date: Feb. 16, 2023

(54) METHOD AND SYSTEM TO DETERMINE COUPLING-TYPE-INDEPENDENT WORKING HEIGHTS OF A PLURALITY OF AGRICULTURAL ATTACHMENTS

(71) Applicant: CLAAS Tractor SAS, VéIizy-Villacoublay Cedex (FR)

(72) Inventors: Jan Carsten Wieckhorst, Uelzen Ortsteil Hanstedt 2 (DE); Christian Ehlert, Bielefeld (DE); Christian Birkmann, Versmold (DE); Jona Pieper, Nordkirchen (DE); Christian Schaub, Paderborn (DE)

(73) Assignee: CLAAS Tractor SAS, VéIizy-Villacoublay Cedex (FR)

(21) Appl. No.: 17/880,913

(22) Filed: Aug. 4, 2022

(30) Foreign Application Priority Data
Aug. 10, 2021 (DE) 102021120758.4

(51) Int. Cl. A01B 79/00; A01B 63/00; A01B 63/32; A01B 59/06

(52) U.S. Cl. CPC A01B 79/005; A01B 63/008; A01B 63/32; A01B 59/066

(57) ABSTRACT

A method and system for determining working heights independent of the type of coupling of a plurality of agricultural attachments using a sensor assembly is disclosed. The sensor assembly includes at least one sensor for recording measured data and a control assembly. The attachments may be coupled to an agricultural production machine by an equipment interface using different types of coupling. The attachments are temporarily coupled to the agricultural production machine using the different types of coupling. The control assembly determines the working heights independent of the type of coupling of the differently coupled attachments when in a coupled state by using the same sensor. The control assembly displays the working heights determined independent of the type of coupling by means of the agricultural production machine, and/or uses them to control and/or regulate the agricultural production machine.

### CROSS REFERENCE TO RELATED APPLICATION

This application claims priority under 35 U.S.C. § 119 to German Patent Application No. DE 102021120758.4 with filing date Aug. 10, 2021, the entire disclosure of which is hereby incorporated by reference herein. This application is further related to: US Utility application Ser. No. ______ (attorney docket no. 15191-22008A (P05464/8)); US Utility application Ser. No. ______ (attorney docket no. 15191-22010A (P05466/8)); US Utility application Ser. No. ______ (attorney docket no. 15191-22011A (P05469/8)); US Utility application Ser. No. ______ (attorney docket no. 15191-22012A (P05470/8)); US Utility application Ser. No. ______ (attorney docket no. 15191-22013A (P05499/8)), each of which are incorporated by reference herein in their entirety.

### TECHNICAL FIELD

The present invention relates to a method and system for determining the working height of a plurality of agricultural attachments independent of the type of coupling, a sensor assembly, and an agricultural production machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Agricultural production machines, such as combines, forage harvesters, and tractors, may be combined with various attachments. These attachments may be attached via an equipment interface to the agricultural production machine. In one instance, the focus is on agricultural combinations of an agricultural production machine with an agricultural attachment, wherein the agricultural attachment may be an independent vehicle. The agricultural attachment may be pulled by the agricultural production machine.

Such attachments generally serve to perform an agricultural job, such as fieldwork. The fieldwork may, for example, be sowing or fertilization processes, the application of pesticides, working the soil like plowing, or harvesting processes like mowing. Common to these types of fieldwork is that the attachments are generally adjusted to a specific working height. The working height may, for example, also assume a negative value, for example in case of plowing, and may therefore be a working depth. The success, and to an extent the energy consumption of the fieldwork, may largely depend on the working height. At the same time, however, it depends on various machine parameters of the attachment of the agricultural production machine.

When plowing, for example, the working height depends on the one hand on parameters that are manually adjusted on the plow by the user depending on the plow, and on the other hand on settings of the equipment interface on the agricultural production machine. Moreover, an axial load and tire pressure of the agricultural production machine, via the tire suspension, may have an indirect influence on the working depth of the plow.

In practice, various types of regulation are used for fieldwork, in particular traction regulation, slip regulation, position regulation, and mixed regulation of traction and position regulation. The working height is automatically adjusted in the process, wherein an attempt is made to keep the working height generally constant.

### BRIEF DESCRIPTION OF THE DRAWINGS

The present application is further described in the detailed description which follows, in reference to the noted drawings by way of non-limiting examples of exemplary implementation, in which like reference numerals represent similar parts throughout the several views of the drawings, and wherein:

FIG. 1 illustrates an agricultural fleet with the proposed sensor assembly while the proposed method is being performed,

FIGS. 2A-D illustrate different attachments with which the proposed method may be performed, and

FIG. 3 schematically illustrates the regulation of working heights of an attachment designed as a plow.

### DETAILED DESCRIPTION

The working depth of modern plows may be adjusted somewhat by hydraulic cylinders; however, the needed measured data to specifically make the settings (and the adjustments) may be absent. Further, there may be similar problems with other types of agricultural attachments. Moreover, various machine parameters of the agricultural production machine, such as the tire pressure, are typically not even considered. Only a relative working height measurement is therefore used. In some known systems, the relative measurement of the working height refers to or references the agricultural production machine. In other known systems (see WO 2019/158454 A1), the working height or working depth is measured relative to the attachment itself.

Nevertheless, it is a challenge to economically determine a working height, and/or economically offer a way to influence the working height. As such, a method and system are disclosed for optimizing with respect to the aforementioned challenge. In particular, in one or some embodiments, a method for determining coupling-type independent working heights of a plurality of agricultural attachments using a sensor assembly is disclosed. The sensor assembly has at least one sensor for recording measured data and a control assembly that may be in communication with one another. The attachments may be coupled to an agricultural production machine by at least one equipment interface using one of a plurality of different types of coupling. In this way, the attachments may be temporarily or reversibly coupled to the agricultural production machine using one of the plurality of different types of coupling. Further, the control assembly may determine the working heights independently of the specific type of coupling (selected from the plurality of different types of coupling). The determination may be performed by using the at least one sensor (such as a single sensor that records the measured data) when in the coupled state. Further, the determined working height may be used in one of several ways, including one or both of: the control assembly displays the working heights, which was determined independently of the type of coupling, in one of several ways (using the agricultural production machine); or uses the determined working height to control and/or regulate one or both of the agricultural production machine or the agricultural attachment.

Thus, in one or some embodiments, the working height of a plurality of attachments, coupled in different ways or types of coupling, may be determined by using one sensor. This reuse of a sensor to determine the working height makes it possible to determine and use the working height in an economical manner. It is thus disclosed to design this sensor such that a working height may be determined that is independent of the selected type of coupling of the attachment. In particular, in one or some embodiments, an absolute working height is determined.

In one or some embodiments, the control assembly determines the working height entirely independently of the type of coupling, and/or entirely independently of the equipment interface, and/or at least partly determines (such as exclusively and entirely determines) the working height using the sensor. In particular, the modular sensor system, explained below, may be used. One advantage of this is this arrangement may simplify data processing significantly. For example, in a best case scenario, the same algorithm may be used to determine the working height of completely different attachments and/or different types of coupling.

The sensors may be placed in one of several options. In one option, the sensor may be attached on the agricultural production machine. This allows the sensor (which may comprise an optical sensor such as a camera) to, for example, remain permanently on the agricultural production machine, and data integration is simplified. In contrast, the complexity of determining the working height increases.

In another option, the sensor may be reversibly mounted on the attachments. An expensive sensor may therefore also be used to determine the working height in a cost-efficient manner in order to determine the working height of a plurality of attachments. In many cases, it is easier to determine the working height on the attachment itself In such an arrangement, the sensor may always (or permanently) be mounted on the attachment.

Further, various types of sensors are contemplated. For example, the sensor may comprise a contact-free distance sensor, which may function on the basis of electromagnetic waves, or acoustic waves, or mechanical sensing. Example contact-free distance sensors is a radar sensor, a lidar sensor, an optical sensor, an ultrasonic sensor, or a force sensor or position sensor, on a component touching the ground (e.g., a part of the sensor apparatus comprises a sensing bracket, a grinding skid or a support roller). Accordingly, in one embodiment, the sensor comprises a distance sensor that may operate free of contact. Further, attaching a distance sensor in a modular way to a plurality of attachments may create an easy yet effective way to measure working heights of the plurality of attachments. The indicated types of sensors may be particularly suitable for use in the agricultural sector. In one or some embodiments, the sensor is robust, for example against vibrations, and may also function reliably even when there is a large amount of dust, dirt, different temperatures, and in different environments.

In one or some embodiments, the attachments may comprise different types of attachments for which the control assembly determines the working height depending on the coupling. The different types of attachments may comprise at least one type of soil cultivation device (e.g., at least two types of soil cultivation devices). The types of soil cultivation devices may comprise any one, any combination, or all of: a plow; a cultivator; or a harrow. Further, the different types of attachments may comprise any one, any combination, or all of: a seeder; an artificial fertilizer spreader and/or a seeder (e.g., a sowing coulter); a mower; a pickup; or an attachment with a pickup (e.g., a baler or a loader wagon). Thus, in one embodiment, the control assembly may support at least two, at least three, at least four, at least five, at least six types of attachments, thereby increasing the cost efficiency of the sensor.

In one or some embodiments, the control assembly determines a plurality of working heights independent of the type of coupling for at least one of the attachments (e.g., for a plurality of the differently coupled attachments). In one or some embodiments the sensor assembly includes a plurality of sensors. The control assembly may use one sensor in each case to determine one of the working heights independent of the type of coupling on the same attachment. More specifically, the control assembly may use a plurality of sensors to determine working heights independent of the type of coupling of the differently coupled attachments. In particular, various attachments, such as plows, have a plurality of working heights since they may also have a longitudinal or transverse inclination. Accordingly, the control assembly may have a plurality of coupling-type-independent working heights. Homogeneous fieldwork may therefore be ensured.

In one or some embodiments, the control assembly regulates a working height of the attachment, taking into account the determined coupling-type-independent working height of the attachment. More specifically, the control assembly regulates the working height of the particular attachment to a predetermined target working height and, to accomplish this, feeds back the coupling-type-independent working height and offsets it against the target working height. For example, to regulate the working height of the attachment, the control assembly may modify a machine parameter, such as a manipulated variable of the regulation, of one or both of the attachment or the equipment interface. In this way, the control assembly may be configured regulate a working height of the attachment. Given the determination of the coupling-type-independent working height and the usability of the sensor assembly for various attachments that may also not have their own sensor system, many cycles of fieldwork may be improved or optimized. It is also contemplated to harmonize various working heights with each other and/or local conditions of the field.

In one or some embodiments, the control assembly regulates at least two working heights of the attachment. For example, the control assembly regulates any one, any combination, or all of: a deviation of the working heights at at least two positions of the attachment; a transverse inclination of the attachment and/or a longitudinal inclination of the attachment. For example, the control assembly may minimize the deviation of the working heights, and/or the transverse inclination and/or the longitudinal inclination, or the control assembly (via executing one or more commands to control the at least one machine parameter) regulates it to a predetermined value. In this regard, the control assembly may regulate at least two working heights of the attachment, thereby allowing for fieldwork to be done more precisely. Accordingly, a longitudinal and/or transverse inclination of the attachment may also be minimized.

In one or some embodiments, the control assembly may vary at least one manipulated variable to regulate the working height. The at least one manipulated variable may be a machine parameter of one or both of the agricultural production machine or the attachment. For example, the control assembly may control the equipment interface to which an attachment is at least temporarily coupled. In particular, the equipment interface may comprise a three-point power lifter, and with the control assembly modifying a manipulated variable (as a machine parameter that may serve as a regulated variable) that regulates the three-point power lifter. The three-point power lifter may have a major influence on the working heights of various attachments and may be simultaneously under the control of the agricultural production machine independent of the attachment.

In one or some embodiments, one of the attachments is a plow, and a manipulated variable of the regulation is a machine parameter (e.g., a pressure of a hydraulic system of the plow). Alternatively, or in addition, one of the attachments is a cultivator or a harrow, and a manipulated variable of the regulation is a machine parameter of the cultivator or the harrow (e.g., the machine parameter is a roller or a support wheel, such as a height of the roller or the support wheel, of the cultivator or the harrow). In this way, the control assembly may regulate the working height of various attachments by controlling one or more machine parameters.

In one or some embodiments, the determined coupling-type-independent working height may relate to a position on the attachment that lies in the driving direction of the agricultural production machine in front of a position of fieldwork of the attachment. More specifically, the control assembly may proactively regulate at least one working height at the position of the fieldwork, such as regulate the at least one working height in real time. This may allow for predictive regulating.

In one or some embodiments, the target working height of the regulation may vary during the fieldwork (e.g., within a single session of fieldwork, the target working height may vary). The control assembly may determine the dynamic or changing target working height based on any one, any combination, or all of: the location (e.g., a current location) of the agricultural production machine; the target working height(s) as specified by the user; or the measured data from the ground sensor (e.g. the control assembly determines the target working height(s) based on measured data from the ground sensor). In this way, the target working height, used for the regulation, may vary while working the field. Conventionally, constant working heights are frequently used, or working heights that change depending on a regulation of a different parameter. With the disclosed solution, it is possible to flexibly adapt the working height to the conditions of the field. This takes the fact into account that the soil and the vegetation on a field may not be homogeneous.

In one or some embodiments, a sensor assembly is disclosed for determining coupling-type-independent working heights of a plurality of agricultural attachments, wherein the sensor assembly has at least one sensor for recording measured data and a control assembly, and wherein the attachments may be coupled by at least one equipment interface using different type of coupling to an agricultural production machine.

In one or some embodiments, the control assembly is configured to determine the coupling-type-independent working heights of the differently coupled attachments when in a coupled state by using the same sensor, and the control assembly is configured to display the working heights determined independent of the type of coupling using the agricultural production machine, and/or to use them to control and/or regulate the agricultural production machine. Reference is made to all statements regarding the proposed method.

In one or some embodiments, an agricultural production machine is disclosed that includes the disclosed sensor assembly. Reference is made to all statements regarding the proposed method and the proposed sensor assembly.

Referring to the figures, the disclosed solution may be applied to a wide range of agricultural production machines 1, such as self-propelled agricultural production machines 1. This includes prime movers (e.g., tractors), and harvesting machines (e.g., combines, forage harvesters, or the like).

In the embodiment depicted, the agricultural production machine 1 is a tractor. The agricultural production machine 1 may be equipped via at least one equipment interface 2 with at least one agricultural attachment 3. The equipment interface 2 may comprise a mechanical coupling between the agricultural production machine 1 and the agricultural attachment 3. In the depicted embodiment, the equipment interface 2 is designed as a three point power lifter 4 that has two lower links 5 and one upper link 6 for coupling to the agricultural attachment 3. The equipment interface 2 may be designed as a front or rear power lifter. In principle, the equipment interface 2 may also be a ball hitch. Other versions of the equipment interface 2 are systems with a simple drawbar coupling, with hitch hooks, with a ball head coupling, or the like.

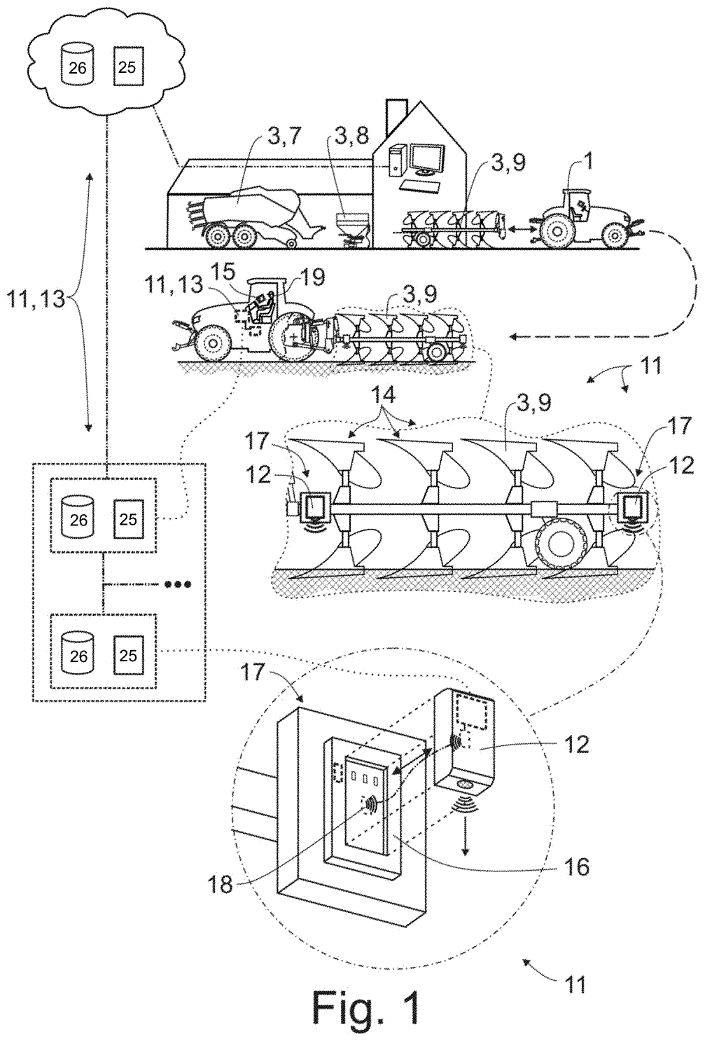

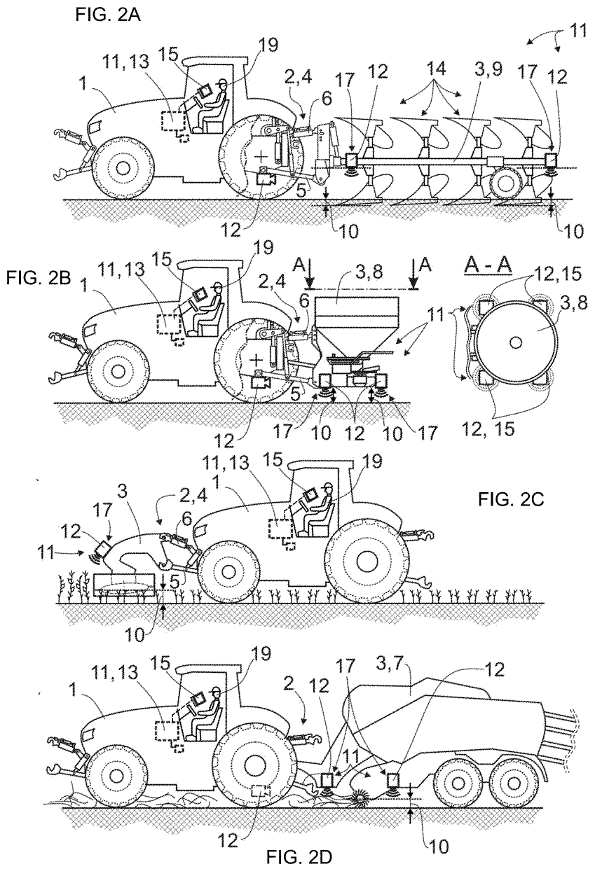

FIG. 1 shows several agricultural attachments 3 that may be used in the disclosed method, specifically a baler 7, an artificial fertilizer spreader 8, and a plow 9. These are shown in action in FIGS. 2A-D.

The embodiment shown in the figures relates to a method and system for determining working heights 10 independent of the type of coupling of a plurality of agricultural attachments 3 using a sensor assembly 11, wherein the sensor assembly 11 has at least one sensor 12 for recording measured data and a control assembly 13, wherein the agricultural attachments 3 may be coupled to an agricultural production machine 1 by at least one equipment interface 2 using different types of coupling, and wherein the agricultural attachments 3 are temporarily and/or removably coupled to the agricultural production machine 1 using different types of coupling.

The sensor 12 may transmit the measured data to the control assembly 13. The different types of coupling may relate to a differing use(s) of the same equipment interface 2, the connection of different agricultural attachments 3, and/or different equipment interfaces 2. In one or some embodiments, at least two different types of coupling are used in the disclosed method. These at least two different types of coupling may be used at different times. For example, a plow 9 may be attached to a rear power lifter, whereas a mower may be fastened to the front power lifter during harvesting.

In one or some embodiments, the term “coupling-type-independent working height” means a working height 10 that is not calculated relative to the equipment interface 2. Specifically, for example incomplete coupling or a change in the coupling should not have an influence on the determined working height 10 as long as it does not interfere with the measurement.

The sensor assembly 11, as such, may be integrated independently at least partially in the agricultural production machine 1. In particular, the control assembly 13 of the sensor assembly 11 may, for example, be a control assembly 13 of the agricultural production machine 1. Likewise, this may, however, also comprise (or consist of) distributed computing units. The control assembly 13 may, for example, have a control unit of the agricultural production machine 1 and a cloud control unit. In this regard, the control assembly 13 may comprise a standalone and dedicated device, or may be integrated in another device. Further, the control assembly 13 may be resident in the agricultural production machine 1 or may reside elsewhere.

The various assemblies, such as sensor assembly 11 and/or control assembly 13, may comprise any type of computing functionality, such as at least one processor 25 (which may comprise a microprocessor, controller, PLA, or the like) and at least one memory 26. This is illustrated, for example, in FIG. 1, with the computing functionality equally applied to each of FIG. 2A-D or 3. The memory 26 may comprise any type of storage device (e.g., any type of memory). Though the processor 25 and memory 26 are depicted as separate elements, they may be part of a single machine, which includes a microprocessor (or other type of controller) and a memory. Alternatively, processor 25 may rely on memory 26 for all of its memory needs.

The processor 25 and memory 26 are merely one example of a controller assembly configuration. Other types of controller assembly configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

Using the sensor 12, an absolute working height 10 may be measured as the working height 10 independent of the type of coupling. In one or some embodiments, the term “absolute” is not necessarily to be understood as a precise measurement, but generally as a measurement relative to the soil. It is contemplated for the measurement to be relative to a component whose height relative to the soil is known. In one or some embodiments, however, the absolute working height 10 is measured directly relative to the soil. It may also be a working depth if the agricultural attachment 3 enters into the soil. In principle, the working height 10 relates to a component of the agricultural attachment 3 that serves to work the field. This fieldwork may however also be sowing or the like. For example, the absolute working height 10 relates to the distance of a plowshare 14 to the soil, in this case generally the working depth, the distance of a discharge of an artificial fertilizer spreader 8 or sprayer to the soil, or the like. In one or some embodiments, the focus is on the soil cultivation equipment, which is why the working height 10 may comprise a working depth.

The sensor 12 may be transmit the measured data to the control assembly 13 in any manner whatsoever. In particular, the sensor 12 need not have to actively send the data; rather, the sensor 12 may also be read out. In one or some embodiments, the transmission is regular and/or continuous.

In one or some embodiments, the control assembly 13 determines the working heights 10 independent of the type of coupling of the differently coupled agricultural attachments 3 when in a coupled state by using the same sensor 12, and the control assembly 13 displays the working heights 10 determined independent of the type of coupling using the agricultural production machine 1, and/or uses the determined working height 10 to control and/or regulate one or both of the agricultural production machine 1 or the agricultural attachment 3.

An example of controlling the agricultural attachment 3 by the agricultural production machine 1 is explained below. A control may be defined analogously. The display of the working height 10 independent of the type of coupling may be on a terminal 15 of the agricultural production machine 1. Alternatively, or in addition, the display of the working height 10 may also be on a smartphone, a tablet, a laptop, a smartwatch, or the like.

In one or some embodiments, the same sensor 12 is used in multiple contexts or ways. As explained further below, this sensor 12 may be located on the agricultural production machine 1. Another disclosed option is to reuse the sensor 12 on different agricultural attachments 3, as explained further below. The figures show both options and several sensors 12 overall. Likewise, however, also just one of the shown sensors 12 may be present.

In addition, it is contemplated for the control assembly 13 to at least partially document the working heights 10 independent of the type of coupling, such as transfer them to documentation of fieldwork. For example, the control assembly 13 may store the determined working heights 10 for transfer to another external device in order to document the fieldwork.

In one or some embodiments, the control assembly 13 determines the working height 10 completely independently of the type of coupling, and/or completely independent of the equipment interface 2. In addition or alternatively, in one or some embodiments, the control assembly 13 determines the working heights 10 primarily, such as exclusively, using the sensor 12.

In one or some embodiments, the term “completely independent” is to be understood as meaning that no features, parameters, settings, etc. of the type of coupling, or respectively equipment interface 2, are taken into account when determining the working height 10. Independent thereof, the settings of the equipment interface 2 may however be manipulated variables of the regulation to be explained below (e.g., the control assembly 13 may control the working height by command the modification of settings of the manipulated variables.

If the working height 10 is primarily determined using the sensor 12, other sensors 12 may be used supportively. A stereo camera, in contrast, would count as a sensor 12 in this case. Determining the working height 10 from a plurality of parameters, inter alia a tire pressure sensor for example, does not count as determining primarily by the tire pressure sensor.

Two exemplary embodiments of the sensor 12 are explained in the following. The sensor 12 may either be attached to the agricultural production machine 1 or to the agricultural attachment 3. Alternatively, the sensors 12 may be attached to both the agricultural production machine 1 and the agricultural attachment 3.

In one or some embodiments, the sensor 12 is attached to the agricultural production machine 1, with the sensor 12 being an optical sensor 12 (e.g., a camera).

In one or some embodiments, the camera is a stereo camera. The sensor 12 on the agricultural production machine 1 may measure the working height 10 contact-free on the agricultural attachment 3. In one or some embodiments, no machine parameters of the agricultural production machine 1 are taken into account in performing the measurement. It may, however, be provided that a positioning of the sensor 12 is taken into account while determining the working height 10. Information on the nature and/or type of the agricultural attachment 3 may also be taken into account.

In the following, the disclosed modular sensor system and the agricultural attachment 3 are explained in greater detail. Within the scope of the modular sensor system, the sensor 12 may be reversibly mounted on the agricultural attachments 3, and the sensor 12 may be used to determine the working height 10 of a plurality of agricultural attachments 3. In one or some embodiments, the sensor may always be mounted on the agricultural attachment 3 to do this.

In one or some embodiments, the sensor assembly 11 may have at least one sensor holder 16, wherein the sensor 12 is reversibly mounted at a mounting position 17 on different agricultural attachments 3 using the at least one sensor holder 16, wherein the sensor 12, in a mounted state, records measured data relating to a working height 10 of the agricultural attachment 3 and transmits the measured data to the control assembly 13. In turn, the control assembly 13 determines, using the measured data, the working height 10 of the particular agricultural attachment 3 from a calibration dataset specific to the mounting position.

In one or some embodiments, the sensor 12 is mounted using the sensor holder 16 at the mounting position 17 such that the mounting is nondestructively reversible. In one or some embodiments, this mounting may not be done during manufacture of the agricultural attachment 3; instead, in one or some embodiments, it is contemplated to mount the sensor holder 16 on site on the field using simple tools, or entirely without tools.

The calibration data set, as explained below, may be saved in any desired memory, created new, or provided to the control assembly 13 in a different way.

In one or some embodiments, the modular sensor system relates to the measurement of the working height 10 of an agricultural attachment 3 that does not have its own electronics. As will be seen below, the sensor assembly 11 may therefore be independent from the agricultural attachment 3. Alternatively, the sensor 12 does not communicate with the agricultural attachment 3. It may also be contemplated that the sensor 12 may be integrated in electronics of the agricultural attachment 3 or may communicate therewith. Also in the case of agricultural attachments 3 with electronics, the sensor 12 need not communicate directly with the agricultural attachment 3. In one or some embodiments, the sensor assembly 11 may be used with agricultural attachments 3 with and without electronics. Alternatively, in one or some embodiments, the determination of the working height 10, apart from the calibration itself, may be completely independent of the agricultural attachment 3.

In one or some embodiments, the situation is such that the mounting-position-specific calibration data sets comprise a reference height, and/or an orientation of the sensor 12 in the mounted state at the particular mounting position 17, and/or a location of the mounting position 17 relative to the agricultural attachment 3.

The reference height may originate from a calibration routine yet to be explained, and may relate to a height of the mounting position 17 of the sensor 12 in a reference state, such as with a known working height 10. The orientation of the sensor 12 may, for example, be a tilt of or to the sensor 12. This may take into account that the sensor 12 might not measure the shortest distance to the ground. The location of the mounting position 17 relative to the agricultural attachment 3 may be selected from a group of given mounting positions 17 or be determined in another way. FIG. 1, for example, shows two mounting positions 17 on a plow 9. FIGS. 2A-D also show several possible mounting positions 17 on different agricultural attachments 3. As will be explained, it is also possible to measure several working heights 10 per agricultural attachment 3 and thereby record, for example, an angle of the agricultural attachment 3. To accomplish this, it may be necessary to locate the mounting position 17 of one or more sensors 12.

In one or some embodiments, the mounting-position-specific calibration data sets are saved in a memory of (or accessible by) the control assembly 13. In this case, this memory may comprise a local memory of the agricultural production machine 1. In principle, a cloud memory or the like is also contemplated. Calibration data sets relating to mounting positions 17 of at least two, such as at least three, different types of agricultural attachments 3 may be saved in the memory.

As shown in the lower region of FIG. 1, the sensor holder 16 may be mounted separately from the sensor 12 on the different agricultural attachments 3. The sensor 12 may then be reversibly mountable on the sensor holder 16. In one or some embodiments, the sensor holder 16 is a relatively inexpensive mass-produced component, while the sensor 12 itself is relatively expensive. The proposed method allows the expensive sensor 12 to be reused.

For reasons of convenience, however, it may be provided that the sensor holder 16 remains on the agricultural attachment 3. On the one hand, this has clear advantages in the context of the calibration routine yet to be explained, but on the other hand, it enables the sensor holder 16 to be mounted in a stable and more involved manner, while the mounting of the sensor 12 on the sensor holder 16 itself may be relatively simple.

This may also allow the same mounting position 17 to be reused when the sensor 12 is attached again. Accordingly, the mounting-position-specific calibration data set may also be assigned to the sensor holder 16 at the corresponding mounting position 17. In order to depict this assignment, the sensor holder 16 may have an identification feature 18.

In one or some embodiments, the identification feature 18 may be transmitted from the sensor holder 16 to the control assembly 13. Alternatively, this sensor holder 16 does not have its own electronics. In particular, it may therefore also be provided that the sensor 12, such as in the mounted state, reads out the identification feature 18 and transmits the identification feature 18 to the control assembly 13. In one or some embodiments, the sensor holder 16 has an NFC tag. The sensor 12 may then have an NFC reader, through which the sensor 12 reads out the identification feature 18 of the sensor holder 16 and transmits the identification feature 18 to the control assembly 13. Alternatively, the user 19 may enter the identification feature 18 via an input device, such as a smartphone, or read it out with the smartphone. The input device may then communicate with the control assembly 13, or may be part of the control assembly 13. In one or some embodiments, the identification feature 18 may be a QR code that the user 19 reads out, for example in a dedicated app. All these possibilities allow the sensor 12 to be quickly mounted, which leads directly to the usability of the sensor 12 for determining the working height 10.

Additionally or alternatively, a user 19 may select the mounting-position-specific calibration data set from an input unit, such as an input unit of an agricultural production machine 1 that communicates with the control assembly 13, or the control assembly 13 automatically selects the mounting-position-specific calibration data set based on the identification feature 18.

In one or some embodiments, the control assembly 13 performs a calibration routine in which the control assembly 13 generates a mounting-position-specific calibration data set and may saves mounting-position-specific calibration data set in the memory. This calibration routine is explained in greater detail below. In one or some embodiments, in the calibration routine, the control assembly 13 saves a reference height and/or an orientation of the sensor 12 in the mounted state at the particular mounting position 17, and/or a location of the mounting position 17 relative to the agricultural attachment 3 in the mounting-position-specific calibration data set.

In one or some embodiments, the calibration routine is performed on level ground. In so doing, the control assembly 13 may inform the user 19 that he/she should park the agricultural production machine 1 and/or the agricultural attachment 3 on level ground, and/or assume that this has been done. Moreover, in one or some embodiments, the agricultural attachment 3 assumes a reference height. In the case of a plow 9, the reference height may, for example, be established at a working height 10 of zero when the plowshares 14 are placed on the ground. However, in a seeder, it may however happen that the lowest adjustable height and a usual working height 10 are too far apart to calibrate the sensor 12 in this manner and still remain within the specification of the sensor 12 during use. Therefore, it may equally be provided that the user 19 enters or otherwise determines the reference height.

In one or some embodiments, the control assembly 13 uses the sensor 12 in the calibration routine to measure a distance of the sensor 12 from the ground and stores this as the reference height. In one or some embodiments, the mounting position 17, which may be specified by the control assembly 13, need not be precisely maintained by the user 19, especially in the height direction, since it may be removed from the reference height when the working height 10 is determined. In other directions as well, great precision is usually not important due to the tolerances prevailing in agriculture.

If the agricultural attachment 3 has its own setting options for the working height 10, it may be pro-vided that the settings present during the calibration routine are also saved in the mounting-position-specific calibration data record, and changes to these settings may lead to the user 19 being warned, or if necessary, be taken into account using a model of the agricultural attachment 3 when determining the working height 10.

In one or some embodiments, the control assembly 13 directs a user 19 through the calibration routine using an output unit in a natural language dialog. For example, the control assembly 13 specifies a mounting position 17 to the user 19, or the user 19 transmits the mounting position 17, such as by voice entry, to the control assembly 13. In addition or alternatively, the control assembly 13 tells the user 19 a setting of a working height 10 of the agricultural attachment 3, or the user 19 transmits the setting of a working height 10, such as by voice entry, to the control assembly 13, and/or the control assembly 13 tells the user 19 to place the agricultural production machine 1 and/or the agricultural attachment 3 on flat ground.

The dialog may be performed using a voice output device and/or a voice input device of the agricultural production machine 1 and/or a smartphone. However, it is also contemplated to use a terminal 15 of the agricultural production machine 1 and/or the smartphone without voice input and/or output.

In one or some embodiments, the agricultural production machine 1 and/or the agricultural attachment 3 is on level ground during the calibration routine, the user 19 mounts the sensor holder 16 at a mounting position 17 on an agricultural attachment 3 and connects the sensor 12 to the sensor holder 16, and the control assembly 13 performs a calibration routine in which the control assembly 13 may: determine a reference height; generate a mounting-position-specific calibration data set; and saves the mounting-position-specific calibration data set in the memory.

The output unit may be the terminal 15 or the smartphone, and/or may have the voice output device.

In one or some embodiments, the sensor 12 is mountable on the sensor holder 16 in a form fit and/or force fit, such as the sensor 12 is mountable on the sensor holder 16 using a quick-locking device, and/or by means of one or more screws, and/or magnetically, and/or is clipable in the sensor holder 16. In one or some embodiments, the sensor 12 may be mounted on the sensor holder 16 using commercially available tools or without any tools at all.

In one or some embodiments, the sensor holder 16 has a battery and/or an electrical connection unit, such as a cable or an antenna, for connection to the control assembly 13, and/or for transmitting energy from an agricultural production machine 1 to the sensor 12, such as the electrical connection unit has a bus connection, in particular an ISOBUS or CAN bus connection.

Using a sensor holder 16 with such a design, the sensor 12 may be supplied with energy. At the same time or alternatively, the sensor holder 16 may be used to transmit the data from the sensor 12 to the control assembly 13. This is particularly interesting if the control assembly 13 is part of the agricultural production machine 1, or the connection to the control assembly 13 runs via the agricultural production machine 1. If the sensor holder 16 has a cable that may be connected to a bus of the agricultural production machine 1 if necessary, and if the sensor holder 16 remains on the agricultural attachment 3, the wiring only has to be performed once. This is a logical extension of the “plug and play” concept of the sensor assembly 11.

In one or some embodiments, the battery may alternatively be an accumulator. In the same way, the sensor 12 may also have its own battery or accumulator. In particular, it is also contemplated for the sensor holder 16 to have no electronics at all, in which case the NFC tag is not considered as electronics. Provided that the agricultural attachment 3 has its own power supply, which may be powered by the agricultural production machine 1, the sensor 12 may also be connected thereto, in particular via the sensor holder 16.

Moreover, in one or some embodiments, the sensor 12 is an especially contact-free distance sensor, and with the distance sensor functioning on the basis of electromagnetic waves, or acoustic waves, or mechanical sensing. Moreover, in one or some embodiments, the distance sensor is a radar sensor, or a lidar sensor, or an optical sensor, or an ultrasonic sensor, or the sensor 12 is a sensor 12, such as a force sensor or position sensor, on a component touching the ground, in particular a sensing bracket, a grinding skid or a support roller.

In one or some embodiments, the sensor assembly 11 has at least two sensors 12 with different functional principles that are each reversibly mounted on the sensor holder 16. Since the sensors 12 may be used modularly, there may also be a plurality of different sensors 12 that are correspondingly selected depending on the agricultural attachment 3 and/or the agricultural activity that is to be performed. These may each compatible with the same sensor holder 16.

In one or some embodiments, the agricultural attachments 3 comprise different types of agricultural attachments 3 for which the control assembly 13 determines a working height 10 depending on the type of coupling. The different types of agricultural attachments 3 may comprise at least one type of soil cultivation device, such as at least two types of soil cultivation devices. The types of soil cultivation devices may comprise a plow 9, and/or a cultivator, and/or a harrow. The different types of agricultural attachments 3 may comprise a seeder, and/or an artificial fertilizer spreader, 8 and/or a seeder, in particular a sowing coulter, and/or a mower, and/or a pickup, and/or an agricultural attachment 3 with a pickup, in particular a baler 7 or a loader wagon.

In one or some embodiments, at least some of the agricultural attachments 3 are independent vehicles with at least one independent axle and independent wheels. In addition or alternatively, the agricultural attachment 3 may be designed without an axle or wheels and be borne by the tractor or another agricultural attachment 3. In this regard, reference is made to the equipment interfaces 2 already mentioned.

As previously noted, various agricultural attachments 3 have different relevant working heights 10. For example, a plow 9 with several plowshares 14 is shown in FIG. 2A. Each of these plowshares 14 has its own working height 10. If the plow 9 is, for example, strongly angled along its longitudinal axis, optimization of only one working height 10 may not yield optimal results.

In one or some embodiments, the control assembly 13 determines several working heights 10 independent of the type of coupling for at least one of the agricultural attachments 3, in particular several of the differently coupled agricultural attachments 3. In one or some embodiments, the sensor assembly 11 has several sensors 12, the control assembly 13 uses one sensor 12 in each case to determine one of the working heights 10 independent of the type of coupling on the same agricultural attachment 3, such as the control assembly 13 uses the several sensors 12 to determine working heights 10 independent of the type of coupling of the differently coupled agricultural attachments 3.

The embodiments of the one sensor 12 may correspondingly apply to the other sensors 12, wherein different embodiments of the sensors 12 may also be combined.

In one or some embodiments, the control assembly 13 additionally determines the working height 10 from an attachment-specific calibration data set, and the attachment-specific calibration data set comprises kinematics of the particular agricultural attachment 3. In addition or alternatively, the control assembly 13 may additionally determine the working height 10 from a coupling data set, and the coupling data set comprises machine parameters of an equipment interface 2 between the agricultural production machine 1 and the particular agricultural attachment 3, and where the coupling data set may comprise machine parameters of a three-point power lifter 4.

Using the attachment-specific calibration data set and coupling data set, the number of necessary sensors 12 to determine several working heights 10 may be reduced, for example, via an axis transformation using the kinematics of the agricultural attachment 3 or via known machine parameters of the equipment interface 2. The determination of a single working height 10 may also be verified or performed more precisely in this way, if necessary. In one or some embodiments, however, at least one working height 10 may be determined without taking into account the machine parameters of the equipment interface 2.

In principle, the attachment-specific calibration data set may be contained in the mounting-position-specific calibration data set, or vice versa. The coupling data set may be attachment-specific, but does not have to be. It may comprise, for example, lengths of hydraulic cylinders of the equipment interface 2. In one or some embodiments, machine parameters are to be understood as all of the settings, associated sensor measured values, and the like. In one or some embodiments, the machine parameters relate at least partially to machine parameters that have a direct influence on the working height 10 that is to be detected.

In one or some embodiments, the control assembly 13 regulates a working height 10 of the agricultural attachment 3 taking into account the determined coupling-type-independent working height 10 of the agricultural attachment 3. In particular, the control assembly 13 regulates the working height 10 of the particular agricultural attachment 3 to a predetermined target working height 20 and, to accomplish this, feeds back the coupling-type-independent working height 10 and offsets it against the target working height 20, and offsets it against the target working height (e.g., the control assembly 13 controls a value of a manipulated variable of the regulation, which is a machine parameter of the agricultural attachment 3 and/or the equipment interface 2).

All of the aforementioned regulation variables may also include dependent variables that likewise fulfill the purpose of regulation.

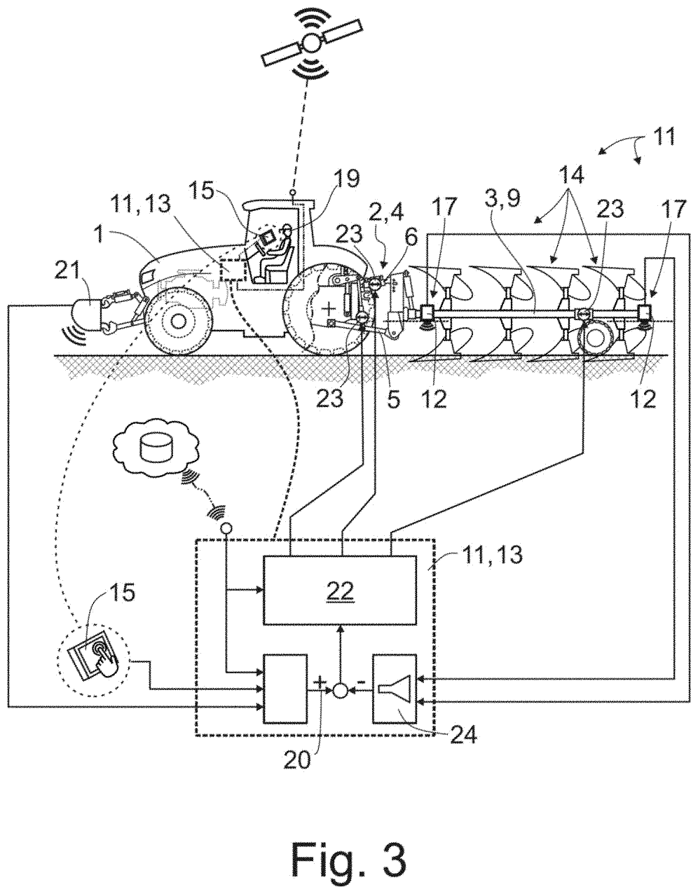

The disclosed sensor assembly 11 enables regulation of the working height 10 of the agricultural attachment 3 that is less complex and more efficient. The target working height 20 may be specified by the user 19, dynamically calculated, originate from a farm management information system, and the like. In one or some embodiments, the target working height 20 takes into account local conditions of the field and/or working heights 10 of previous tasks that, in particular, were also performed by determining a working height 10 with the proposed sensor assembly 11. The regulation is schematically portrayed in FIG. 3. As shown, the target working height 20 may be derived from user input, another system, or a forefield sensor 21. Together with feeding back of the measured working heights 10, the height may find its way into a regulation block 22 from which target values of manipulated variables for actuators 23 are derived.

In one or some embodiments, the machine parameters of the agricultural attachment 3 may for example be settings for hydraulic cylinders that adjust the height of the agricultural attachment 3. Moreover, the machine parameters may be settings for the three-point power lifter 4, in particular, settings for the lower link 5 and/or the upper link 6. In one or some embodiments, the machine parameters serving as manipulated variables may have an influence on the working height 10 to be regulated.

In one or some embodiments, the control assembly 13 regulates at least two working heights 10 of the agricultural attachment 3, such as the control assembly 13 regulating a deviation of the working heights 10 at at least two positions of the agricultural attachment 3, and/or a transverse inclination of the agricultural attachment 3, and/or a longitudinal inclination of the agricultural attachment 3. In particular, the control assembly 13 may minimize the deviation of the working heights 10, and/or the transverse inclination, and/or the longitudinal inclination, or may regulate the working heights 10 to a predetermined value.

When the several working heights 10 of the agricultural attachment 3 are regulated, the kinematics of the agricultural attachment 3 may be taken into account. It is also contemplated to determine the kinematics from the reaction of the agricultural attachment 3 to various manipulated variable changes. To accomplish this, a test run may be provided to adjust the agricultural attachment 3.

In one or some embodiments, the control assembly 13 varies at least one manipulated variable to regulate the working height 10, with the at least one manipulated variable being a machine parameter of the agricultural production machine 1 and/or the agricultural attachment 3. In one or some embodiments, the equipment interface 2 to which an agricultural attachment 3 is at least temporarily and/or removably (e.g., non-permanently) coupled is a three-point power lifter 4, such as a manipulated variable of the regulation is a machine parameter of the three-point power lifter 4.

Other machine parameters that may serve as manipulated variables are, for example, an air pressure of the tires of the agricultural production machine 1, and generally machine parameters of the agricultural production machine 1 that may influence a height of the equipment interface 2. These also comprise, for example, axle loads. Not all of these parameters are, however, always readily adjustable.

As a manipulated variable, input parameters may also serve for position regulation, and/or traction regulation, and/or mixed regulation, and/or slip regulation of the agricultural production machine 1 and its equipment interface 2. This option may allow existing regulations to be built upon.

Moreover, in one or some embodiments, one of the agricultural attachments 3 is a plow 9, that a manipulated variable of the regulation is a machine parameter, in particular a pressure of a hydraulic system, of the plow 9, and/or that one of the agricultural attachments 3 is a cultivator or a harrow, that a manipulated variable of the regulation is a machine parameter of the cultivator or the harrow, that the machine parameter is a roller or a support wheel, in particular a height of the roller or the support wheel, of the cultivator or the harrow.

Previously, the height of mowers and pickups has frequently been guided by direct ground contact with skids, support wheels, and the like. This increases fuel consumption and reduces the output per area by friction or roll resistance. Moreover, damage to the field or the field vegetation may be caused. The device itself is therefore also subject to increased wear. Sometimes, the height is guided following the actual work tools, and generally this tends to be reactive and difficult to effectively control mechanically. All of these advantages may be partially or completely avoided using the disclosed teaching.

In one or some embodiments, the determined working height 10 independent of the type of coupling relates to a position on the agricultural attachment 3 that lies in the driving direction of the agricultural production machine 1 in front of a position of fieldwork of the agricultural attachment 3. Particularly, the control assembly 13 may proactively regulate at least one working height 10 at the position of the fieldwork, such as in real time.

In one or some embodiments, the working height 10 may be adapted or modified in real time to the local conditions by the proactive regulation, or generally the determination of the working height 10, before a position of the fieldwork. In the present case as shown in FIG. 3, a filter 24 may be provided that may, for example, be a low-pass filter depending on the application. When plowing, for example, a fast reaction to the potholes and the like will not occur or will be impossible so that they may be filtered out of the measurement. In other applications, for example with an artificial fertilizer spreader 8, a reaction thereto may also be provided.

In one or some embodiments, the working height 10 is in principle measurable in various positions of the agricultural attachment 3 depending on the application. The measurability is another advantage of the modular sensor system.

Moreover, in one or some embodiments, the target working height 20 of the regulation may vary during the fieldwork, such as the target working height 20 may depend on the location, and/or may be specified by the user 19, and/or may be determined by the control assembly 13 on the basis of measured data from a ground sensor.

Using the disclosed solution, it is possible to adapt the working height 10 during fieldwork to various positions of the field as needed. Correspondingly, a plan for the fieldwork may, in particular, be provided that specifies different target working heights 20 for the field beforehand. This may for example be implemented using a GPS system. Thus, in the context of a fieldwork for a single field, multiple different target working heights 20 may be used.

According to an additional teaching, a sensor assembly 11 is disclosed, in particular for use in the disclosed method, for determining working heights 10 independent of the type of coupling of a plurality of agricultural attachments 3, wherein the sensor assembly 11 has at least one sensor 12 for recording (e.g., sensing or generating) measured data and a control assembly 13, wherein the agricultural attachments 3 may be coupled by at least one equipment interface 2 using different type of coupling to an agricultural production machine 1.

In one or some embodiments, the control assembly 13 is configured to determine the working heights 10 independent of the type of coupling of the differently coupled agricultural attachments 3 when in a coupled state by using the same sensor 12, and the control assembly 13 is configured to display the working heights 10 determined independent of the type of coupling by means of the agricultural production machine 1, and/or to use them to control and/or regulate the agricultural production machine 1. Reference is made to all statements regarding the disclosed method.

Moreover according to an additional teaching, an agricultural production machine 1 is proposed with a proposed sensor assembly of 11. Reference is made to all statements regarding the proposed method and the disclosed sensor assembly 11.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Agricultural production machine
2 Device interface
3 Agricultural attachment
4 Three-point power lifter
5 Lower link
6 Upper link
7 Baler
8 Artificial fertilizer spreader
9 Plow
10 Working height
11 Sensor assembly
12 Sensor
13 Control assembly
14 Plowshare
15 Terminal
16 Sensor holder
17 Mounting position
18 Identification feature
19 User
20 Target working height
21 Forefield sensor
22 Regulation block
23 Actuator
24 Filter
25 Processor
26 Memory

1. A method for determining coupling-type independent working heights of a plurality of agricultural attachments using a sensor assembly, wherein the sensor assembly includes at least one sensor for recording measured data and a control assembly, wherein the plurality of agricultural attachments are coupled to an agricultural production machine by at least one equipment interface using different types of coupling, wherein the plurality of agricultural attachments are temporarily coupled to the agricultural production machine using different types of coupling, the method comprising:
determining, by the control assembly, the working heights independently of the type of coupling of the plurality of agricultural attachments when in a coupled state by using the same sensor; and
performing one or both of:
displaying, by the control assembly, the working heights determined independently of the type of coupling using the agricultural production machine; or
using the working heights to perform one or both of control or regulation of one or both of the agricultural production machine or the agricultural attachment.

2. The method of claim 1, wherein the control assembly determines the working height entirely independently of the type of coupling, and entirely independently of the equipment interface.

3. The method of claim 1, wherein the control assembly determines the working heights exclusively using the sensor.

4. The method of claim 1, wherein the sensor is attached to the agricultural production machine; and
wherein the sensor comprises a camera.

5. The method of claim 1, wherein the sensor is reversibly mounted on the plurality of agricultural attachments;
wherein the sensor is used to determine the working height of a plurality of attachments and is always mounted on the attachment to determine the working height of the plurality of attachments.

6. The method of claim 5, wherein the sensor comprises a contact-free distance sensor;
wherein the distance sensor functions using at least one of electromagnetic waves, acoustic waves, or mechanical sensing; and
wherein the distance sensor comprise at least one of a radar sensor; a lidar sensor; an optical sensor; an ultrasonic sensor; a force sensor; or position sensor positioned on a component comprising at least one of a sensing bracket, a grinding skid or a support roller.

7. The method of claim 1, wherein the plurality of agricultural attachments comprise different types of attachments for which the control assembly determines a working height depending on the type of coupling;
wherein the different types of attachments comprise at least two types of soil cultivation devices; and
wherein the at least two types of soil cultivation devices comprise: a plow; a cultivator; a harrow.

8. The method of claim 1, wherein the control assembly determines a plurality of working heights independently of the type of coupling for a plurality of differently coupled attachments.

9. The method of claim 8, wherein the sensor assembly comprises a plurality of sensors;
wherein the control assembly uses the plurality of sensors to determine the plurality of working heights independently of the type of coupling for the plurality of the differently coupled attachments.

10. The method of claim 1, wherein the control assembly regulates the working height of a respective attachment by considering the determined coupling-type-independent working height of the respective attachment in regulating the working height.

11. The method of claim 10, wherein the control assembly regulates the working height of the respective attachment to a predetermined target working height by feeding back the coupling-type-independent working height and offsetting it against the predetermined target working height.

12. The method of claim 11, wherein the control assembly regulates the working height of the respective attachment by using a manipulated variable of the regulation as a machine parameter of one or both of the respective attachment or the equipment interface.

13. The method of claim 11, wherein the control assembly regulates at least two working heights of the respective attachment; and
wherein the control assembly regulates at least one of:
a deviation of the at least two working heights at at least two positions of the respective attachment;
a transverse inclination of the respective attachment; or.
a longitudinal inclination of the respective attachment.

14. The method of claim 13, wherein the control assembly minimizes at least one of:
the deviation of the working heights;
the transverse inclination; or
the longitudinal inclination.

15. The method of claim 13, wherein the control assembly varies at least one manipulated variable to regulate the working height;
wherein the at least one manipulated variable is a machine parameter of one or both of the agricultural production machine or the respective attachment;
wherein the equipment interface, to which the respective attachment is at least temporarily coupled, is a three-point power lifter; and
wherein the at least one manipulated variable is a machine parameter of the three-point power lifter.

16. The method of claim 1,
wherein one of the plurality of agricultural attachments is a plow; and
wherein a manipulated variable of the regulation is pressure of at least one of a hydraulic system or the plow;
or
wherein one of the plurality of agricultural attachments is a cultivator or a harrow;
wherein the manipulated variable of the regulation is a machine parameter of the cultivator or the harrow; and
wherein the machine parameter is a height of a roller or a support wheel of the cultivator or the harrow.

17. The method of claim 1, wherein the determined coupling-type-independent working height relates to a position on a respective agricultural attachment that lies in a driving direction of the agricultural production machine in front of a position of fieldwork of the respective attachment; and
wherein the control assembly proactively and in real time regulates at least one working height at the position of the fieldwork.

18. The method of claim 17, wherein a target working height of the regulation varies during the fieldwork; and
wherein preferably the target working height depends on one or more of: a current location; a specified target working height by a user; or the control assembly determining the target working height based on measured data from a ground sensor.

19. A sensor assembly configured to determine working heights independent of a plurality of different types of coupling of a plurality of agricultural attachments, the plurality of agricultural attachments coupled by at least one equipment interface using one of the plurality of different types of coupling to an agricultural production machine, the sensor assembly comprising:
at least one sensor configured to record measured data; and
a control assembly in communication with the at least one sensor, the control assembly configured to:
determine coupling-type-independent working heights of the plurality of different types of coupling when in a coupled state by using the at least one sensor; and
perform one or both of display the coupling-type-independent working heights or use the coupling-type-independent working heights to do one or both of control or regulate the agricultural production machine.

20. An agricultural production machine comprising:
at least one equipment interface for coupling to a plurality of agricultural attachments using one of a plurality of different types of coupling; and
a sensor assembly comprising:
at least one sensor configured to record measured data; and
a control assembly in communication with the at least one sensor, the control assembly configured to:
determine coupling-type-independent working heights of the plurality of different types of coupling when in a coupled state by using the at least one sensor; and
perform one or both of display the coupling-type-independent working heights or use the coupling-type-independent working heights to do one or both of control or regulate the agricultural production machine.
